(19) United States
(12) Patent Application Publication
(10) Pub. No.: US 2025/0370937 A1
(43) Pub. Date: Dec. 4, 2025

(54) SYSTEMS AND METHODS FOR STORAGE CACHE PERSONALIZATION AND OBJECT GENERATION USING ADVANCED COMPUTATIONAL MODELS FOR DATA ANALYSIS AND AUTOMATED PROCESSING

(71) Applicant: BANK OF AMERICA CORPORATION, CHARLOTTE, NC (US)

(72) Inventors: Saurabh Arora, Gurugram (IN); Sandeep Kumar Chauhan, Hyderabad (IN)

(73) Assignee: BANK OF AMERICA CORPORATION, CHARLOTTE, NC (US)

(21) Appl. No.: 18/675,779

(22) Filed: May 28, 2024

(51) Int. Cl. G06F 12/128

(52) U.S. Cl. CPC G06F 12/128; G06F 2212/6024

(57) ABSTRACT

Systems, computer program products, and methods are described herein for storage cache personalization and object generation using advanced computational models for data analysis and automated processing. The present disclosure is configured to receive a user interaction from a user account, wherein the user interaction comprises transaction details associated with a transaction; transmit the user interaction to a service layer, wherein the service layer comprises a personalization knowledge model and a bronze storage, wherein the bronze storage comprises unmodified data associated with the user interaction; determine a candidate element, wherein the candidate element is based on a preference of the user; transmit the candidate element to a cache compute engine, wherein the cache compute engine builds a personalized object using the candidate element; and transmit the personalized object to a memory fabric layer, wherein the memory fabric layer is near a user interface of a user device.

### TECHNOLOGICAL FIELD

Example embodiments of the present disclosure relate to storage cache personalization and object generation using advanced computational models for data analysis and automated processing.

### BACKGROUND

There are significant challenges associated with cache management and object generation systems. Applicant has identified a number of deficiencies and problems associated with conventional cache storage and management systems. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for storage cache personalization and object generation using advanced computational models for data analysis and automated processing.

Embodiments of the present invention address the above needs and/or achieve other advantages by providing apparatuses (e.g., a system, computer program product, and/or other devices) and methods for storage cache personalization and object generation using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention receives a user interaction from a user account, wherein the user interaction includes transaction details associated with a transaction, and wherein the transaction is initiated by a user via a user device. In some embodiments, the present invention transmits the user interaction to a service layer, wherein the service layer includes a personalization knowledge model and a bronze storage, wherein the bronze storage includes unmodified data associated with the user interaction. In some embodiments, the present invention determines a candidate element, wherein the candidate element is based on a preference of the user. In some embodiments, the present invention transmits the candidate element to a cache compute engine, wherein the cache compute engine builds a personalized object using the candidate element. In some embodiments, the present invention transmits the personalized object to a memory fabric layer, wherein the memory fabric layer is near a user interface of the user device.

In some embodiments, the transaction details include interaction events and session objects associated with the user interaction.

In some embodiments, transmitting the candidate element to a cache compute engine further includes proactively pulling the candidate element into a silver storage, wherein the silver storage includes the personalization knowledge module enriching the candidate element.

In some embodiments, the personalization knowledge module further includes a large language model (LLM), wherein the LLM proactively determines the candidate element based on historical user interactions.

In some embodiments, the personalization knowledge module further includes generating personalization context of the candidate elements, wherein the personalization context includes transactional updates, wherein the transactional updates include events associated with the user interaction. In some embodiments, the personalization context further includes common updates, wherein the common updates include general configurations associated with the system. In some embodiments, the personalization context includes product rules, wherein the product rules include configurations of products associated with the bronze storage.

In some embodiments, the cache compute engine further includes building the personalized object based on the personalization context provided by the personalization knowledge module.

In some embodiments, the memory fabric layer includes a first layer of interaction for the user device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for storage cache personalization and object generation using advanced computational models for data analysis and automated processing, in accordance with an embodiment of the disclosure;

FIG. 2 illustrates a process flow for storage cache personalization and object generation using advanced computational models for data analysis and automated processing, in accordance with an embodiment of the disclosure; and

FIG. 3 illustrates an example embodiment of the cache personalization and object generation system as described herein, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In the modern world, users demand personalized user experiences more and more each day. To meet these demands, computing systems must be able to handle the vast amount of personalization that an ever-growing number of users seek. The large user base coupled with the personalization of each user's experience creates a resource intensive task for conventional computing environments. For example, a user may wish to have an individualized landing page when the user logs in to the user's account. Conventional systems, however, may not be able to handle the personalization the user is expecting due to traditional cache management systems lacking infrastructure designed to have unique personalization experiences at the ready. Typically, a conventional system may respond to a user's request for personalization by caching large, common objects throughout the entire user's experience. These large objects lead to unnecessary data flowing through the system for all customer queries, without regard for the required sub elements expected by different users. In other words, conventional systems waste resources in caching the oversized objects throughout the system. Further, conventional systems operating by relying on configuration-based personalization techniques lack in determining user behavior and context. In this way, conventional systems do not understand the contextual background of organizational policy updates, product rule updates, system of record updates, or the like. Therefore, a layered cache compute architecture capable of proactively pulling updates and which also understands the context of an individual user's sub-elements is introduced.

As described herein, the invention provides for a large personalization model for context build and cache object mapping with a dedicated in-memory compute engine to process and build personalized objects. A regular user login event may trigger the context build and a screen refresh, and subsequent business logic events (relating to what the user is fetching) may be transmitted to a service layer. Metadata may also be passed to a large language model (LLM) for continuous understanding of user preferences. The business logic events (which may include transactional updates from the user interaction) may be passed to system of records (e.g., bronze database), and a feed may be transmitted to the LLM. The LLM may also receive feedback from the bronze storage SORs. Further, the LLM may build context against updates received from the business logic events, common SOR updates, and/or product rule updates. Next, a candidate data element may be chosen, wherein the candidate element determines the information required for caching. The candidate element may also include an expiration time which may dictate how long certain information is cached. The candidate data element may be selected and proactively pulled into a silver storage layer (e.g., silver database) in which specific computation and structured build may be carried out. An in-memory cache compute engine may process data updates (from the candidate data element in the silver storage) and build personalized and structured user specific sub-objects, which may include the contextualization provided by the LLM, that will ultimately be cached. The personalized objects are then pushed to the memory fabric layer, which is the first layer of interaction for client and/or user applications. The user device may directly pull the updated personalized objects from the memory fabric for faster processing.

What is more, the present disclosure provides a technical solution to a technical problem. As described herein, the technical problem includes issues surrounding cache management and object build in conventional systems which lead to ineffective usage of resources associated with processing. The technical solution presented herein allows for personalized objects to be built based on user preferences in an effective and efficient manner. In particular, cache personalization and object generation system (e.g., the system 130 as described herein) is an improvement over existing solutions to cache management for user-specific objects, (i) with fewer steps to achieve the solution, thus reducing the amount of computing resources, such as processing resources, storage resources, network resources, and/or the like, that are being used (e.g., based on proactively pulling candidate elements for specific computation and structured build), (ii) providing a more accurate solution to problem, thus reducing the number of resources required to remedy any errors made due to a less accurate solution (e.g., using a LLM to accurately determine personalized user objects while also providing context for the objects and associated updates), (iii) removing manual input and waste from the implementation of the solution, thus improving speed and efficiency of the process and conserving computing resources (e.g., automating the process of determining personalization of user objects through use of the LLM while also continuously learning user preferences), (iv) determining an optimal amount of resources that need to be used to implement the solution, thus reducing network traffic and load on existing computing resources (e.g., reducing reliance on using large, common object structures which flow through the system for all customer inquiries by proactively generating personalized user specific objects). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the cache personalization and object generation system as described herein is a solution to the problems surrounding cache strategy for performance-oriented applications generating personalization product experiences. Further, the cache personalization and object generation system may be characterized as identifying a specific improvement in computer capabilities and/or network functionalities in response to the cache personalization and object generation system's integration to existing devices, software, applications, and/or the like. In this way, the cache personalization and object generation system improves the capability of a system to personalize and contextualize user specific objects. Further, the cache personalization and object generation system improves the functionality of networks in response to reducing the resources consumed by the system (e.g., network resources, computing resources, memory resources, and/or the like).

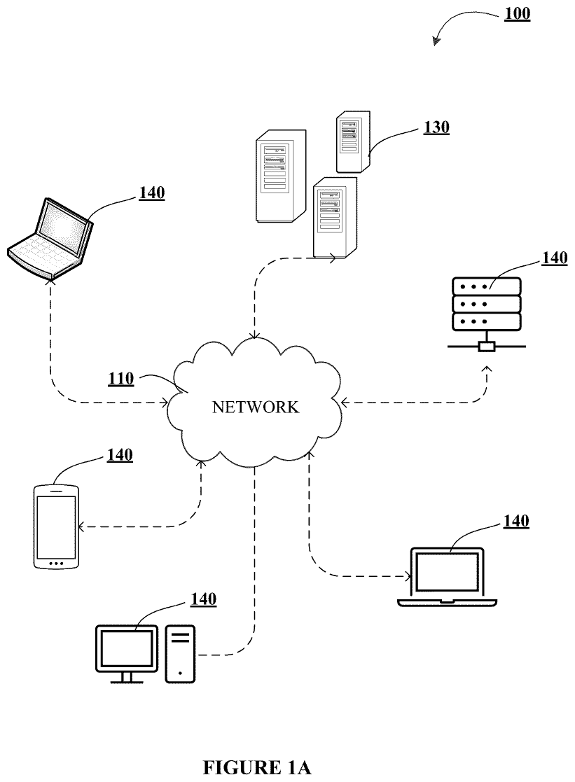

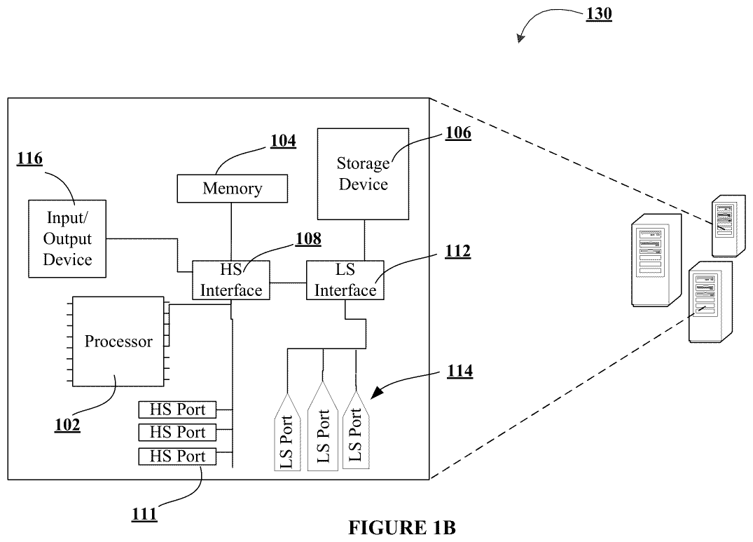

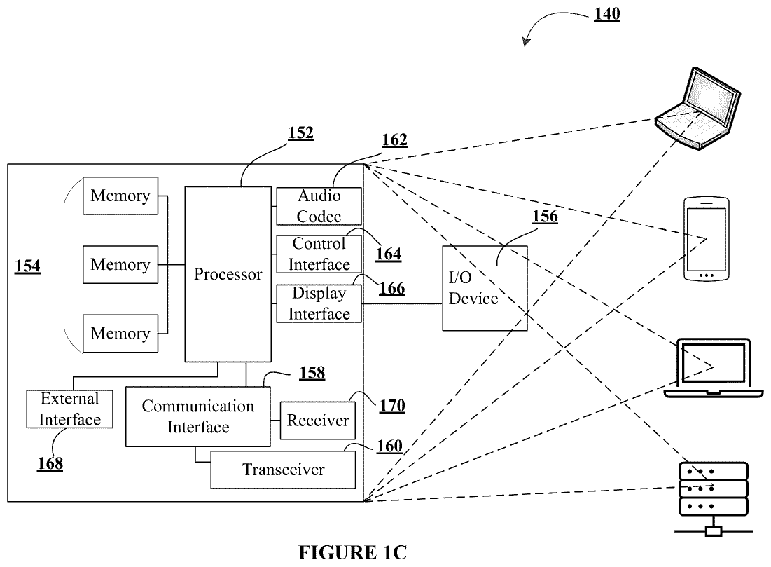

FIGS. 1A-1C illustrate technical components of an exemplary distributed computing environment 100 for storage cache personalization and object generation using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

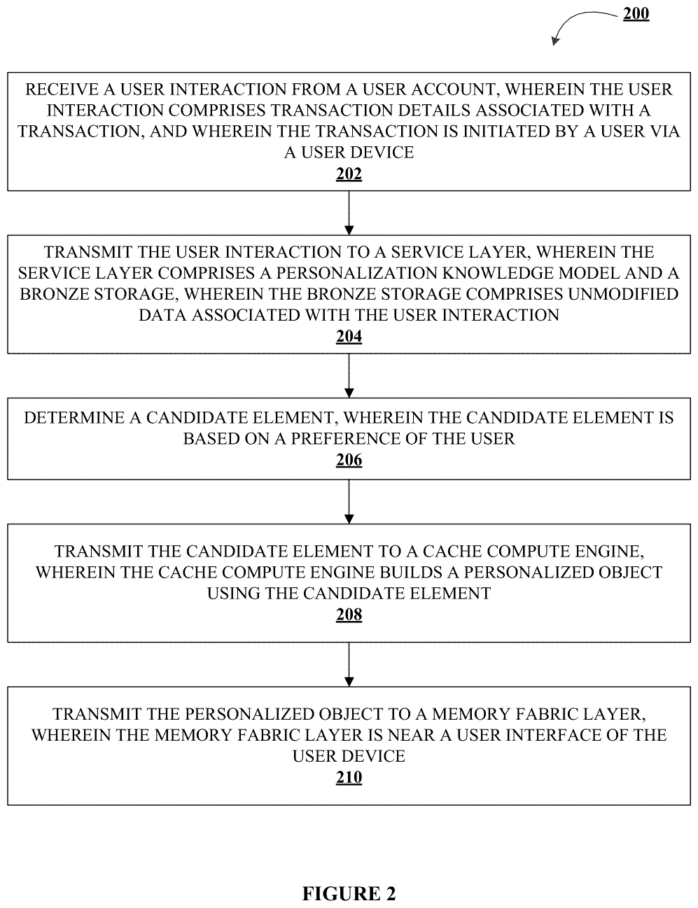

FIG. 2 illustrates a process flow for storage cache personalization and object generation using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a cache personalization and object generation system (e.g., similar to one or more of the systems described herein with respect to FIGS. 1A-1C) may perform one or more of the steps of process flow 200. For example, a cache personalization and object generation system (e.g., the system 130 described herein with respect to FIGS. 1A-1C) may perform the steps of process flow 200.

As shown in block 202, the process flow 200 of this embodiment includes receiving a user interaction from a user account, wherein the user interaction includes transaction details associated with a transaction, and wherein the transaction is initiated by a user via a user device. In some embodiments, the user interaction may include a login to a user account, a navigation throughout an account, a visit to a web page (accessed on a mobile device, personal computer, tablet, etc.), and the like.

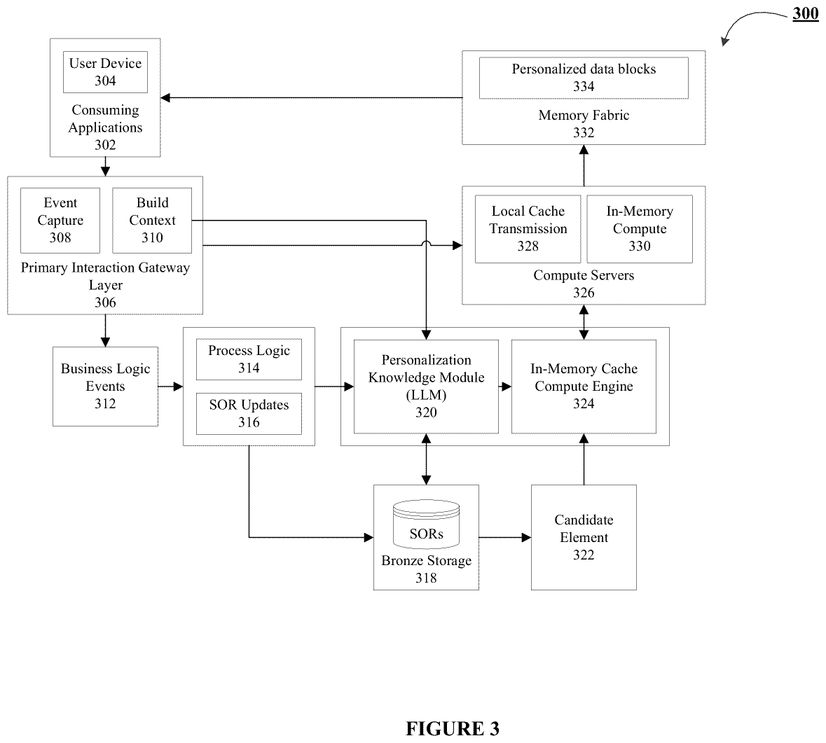

In some embodiments, the transaction details include interaction events and session objects associated with the user interaction. The transaction details may include logs, events, sessions information, objects, sub-objects, data, metadata, and the like related to what the user is fetching during an interaction. For example, the transaction details may include login requests and responses, account information requests and responses, page navigation requests and responses, action requests and responses, data update requests and responses, and the like. For instance, and as shown in FIG. 3, the user device 304, which may be a consuming application 302, may interact with the primary interaction gateway layer 306 where an event capture 308 may occur. In this example, the transaction details may be gathered by the system (e.g., system 130) for further processing, as discussed in greater detail below.

As shown in block 204, the process flow 200 of this embodiment includes transmitting the user interaction to a service layer, wherein the service layer includes a personalization knowledge model and a bronze storage, wherein the bronze storage includes unmodified data associated with the user interaction. In some embodiments, the service layer may include receiving the events relating to the user interaction. These events may include business logic events that relate to the transactional details of the user interaction. Business logic events may include rules, computations, workflows, or the like that ensure the application (or system) the user interacts with behaves correctly. The business logic events may be based on a host entity's rules on how the application and/or system should operate. For example, and as shown in FIG. 3, the business logic events 312 may include information from the primary interaction gateway layer 306 which may include user authentication, account management actions, transaction management, automation tasks, data management, or the like. In this way, the business logic events may enhance the user's experience during the user interaction to ensure the system operates correctly during the interaction.

In some embodiments, the bronze storage may include an enterprise storage layer, data lake, system of record (SOR), or the like. For example, and as shown in FIG. 3, the bronze storage 318 may include an SOR. The bronze storage may be used to store and capture raw, unprocessed data in its original formant as it is captured from the user interaction (e.g., primary interaction gateway layer 306 in FIG. 3). The data capture associated with the user interaction may include clicks, session information, error logs, views, form submissions, requests, metadata, and the like. Further, the bronze storage layer may also include storage of objects relating to the system with which the user is interacting. In this way, the system's object builds, pages, media, data, and the like may be stored in the bronze storage. These objects and associated data may be later pulled from the bronze storage and placed into a silver storage layer, as discussed in greater detail below.

As shown in block 206, the process flow 200 of this embodiment includes determining a candidate element, wherein the candidate element is based on a preference of the user. In some embodiments, the candidate element may include elements, objects, sub-objects, or the like that may eventually be built according to personalized data blocks specific for a user interaction. The candidate elements may include objects the system may determine to be relevant to a user interaction. Further, the candidate element may relate to caching strategies for user specific objects and sub-objects. In this way, the candidate elements may include cache expiration times relating to the objects used in the user interaction. The candidate element may provide insight as to what the user interaction is based around, what objects should be generated in order for the user to continue the interaction, and how long those objects should be cached. For example, if an application that allows users to make bookings for an overnight stay, the system may determine that candidate elements relate to showing media, descriptions, action items, user forms, and the like for the destination's the user is considering. Further, the candidate element may define how long those objects should be stored in the cache. In this way, the candidate elements may include objects and elements that should be available to the user to make a seamless user interaction.

In some embodiments, the candidate elements may, before they are chosen as candidate elements, be stored in the bronze storage. The candidate elements may be part of bulk system storage until they are needed for a user interaction. For example, as shown in FIG. 3, the candidate element 322 may come from the bronze storage 318.

In some embodiments, the personalization knowledge module further includes a large language model (LLM), wherein the LLM proactively determines the candidate element based on historical user interactions. In some embodiments, the historical user interactions may include prior interactions by the user with the system. These historical interactions may be used by the LLM to determine an expected or projected user interaction with a current user interaction. The LLM may learn a user's habits, preferences, tendencies, or the like that the user performs during the interaction. For example, if the application involves bookings for an overnight stay, the personalization knowledge module (e.g., the LLM) may learn a user's preferences as the user interacts with the application. In this example, if the user checks a particular destination's availability on a regular interval, the LLM may learn and understand the user will be checking that destination's availability in the future, also. Further, the system may proactively determine the candidate element(s) relating to loading the correct information for the user to check the destination.

Additionally, or alternatively, the LLM may determine an appropriate cache expiration time of the candidate element to schedule it for deletion from the cache to improve resource effectiveness of the system. In some embodiments, the candidate elements may be unique for each user of the system which may provide benefits for resource management and user experience. In this way, the cache expiration time may be adjusted on a user-by-user basis, in order to effectuate a user experience that allows for quick response from the system and efficient resource management.

In some embodiments, the personalization knowledge module further includes generating personalization context of the candidate elements, wherein the personalization context includes transactional updates. The transactional updates may be related to updates dealing with the transaction, or interaction, associated with the user. In this way, the transactional updates may include the business logic events because they capture the user interaction session information. In some embodiments, the personalization knowledge module may also capture context from the user device. For example, as shown in FIG. 3, the build context 310 of the user device 304 in the primary interaction gateway layer 306 may be passed to the personalization knowledge module 320. In this example, the build context 320 may include relevant user device 304 information that may contribute to the personalization knowledge module's 320 operations. For example, the user device's performance specifications, memory capacity, physical features, input capabilities, and the like may determine context relating to the user device. Further, the build context 310 may include user-specific objects and the like that may be used to build the personalized data blocks 334.

Further, in some embodiments, the personalization context includes common updates, wherein the common updates may include general configurations associated with the system. The common updates may include updates that affect objects and sessions on a system-wide basis. The common updates may impact interactions across the entire system, including user interactions from all users interacting with the system. In this way, the common updates may be general updates to system architecture, infrastructure, applications, interfaces, objects, sessions, or the like. In some embodiments, the common updates may include SOR updates, organizational policy changes, or the like. For instance, as shown in FIG. 3, the SOR updates 316 may update the bronze storage database 318 while also being fed to the personalization knowledge module 320. Further, with reference to FIG. 3, the process logic 314 may be used for data identification of incoming data to the personalization knowledge module 320.

Further still, in some embodiments, the personalization context includes product rules, wherein the product rules may include configurations of products associated with the bronze storage. The product rules may affect specific products a user may interact with during the user interaction. The products a user interacts may be updated from time to time to include updated descriptions, explanations, features, media, or the like associated with the product. For instance, a product rule may be updated to state a certain product the user interacts with has been re-named. In this example, the product rule will update the product to the proper name and affect the product throughout the system. The personalization knowledge module may take the newly updated product into consideration throughout its operation.

Further, in some embodiments, the personalization knowledge module may consider the user specific preferences, historical interactions, transactional updates, common updates, and product updates to generate a candidate element. As discussed above, the information used to generate the candidate element may determine what type of object, sub-object, information, cache expiration time, or the like should govern the candidate element. The information contextualized by the personalization knowledge module may create specific candidate elements for each user, and subsequently specific caching strategies, as well. In other words, the system-wide policies along with user-based interactions may affect the caching strategies for each user's personalized experience.

Additionally, or alternatively, as the user's habits change, the caching strategies may change, also. For example, if a user is, for a short time, frequently checking account details due to an updated home address, the system may proactively generate candidate elements relating to the user's address and account details. In this way, the system may alter expiry times relating to objects storing account detail information to make those objects more readily available for the user. As the user checks the account details with less frequency, the system may adjust the caching strategy based on the new user preferences and to maximize efficient usage of resources.

As shown in block 208, the process flow 200 of this embodiment includes transmitting the candidate element to a cache compute engine, wherein the cache compute engine builds a personalized object using the candidate element. In some embodiments, transmitting the candidate element to a cache compute engine further includes proactively pulling the candidate element into a silver storage, wherein the silver storage includes the personalization knowledge module enriching the candidate element. The candidate elements may be pulled from the bronze storage layer and moved to a silver storage layer. In some embodiments, the silver storage layer may be associated with the in-memory cache compute engine. The in-memory cache compute engine may allow for faster processing because of the reduced processing load by pre-selecting the candidate elements from the bronze storage layer. In some embodiments, the silver storage may include a smaller number of elements than the bronze storage, allowing for faster processing. In other words, the LLM's determination of the candidate elements and associated caching strategy allows for efficient processing of the candidate elements. For example, and as shown in FIG. 3, a candidate element 322 may be pulled from the bronze storage 318 and stored in the in-memory cache compute engine 324. In some embodiments, the silver storage layer (not shown in FIG. 3) may be associated with the in-memory cache compute engine 324.

In some embodiments, the candidate element may be proactively pulled into the silver storage layer. In this way, the system may determine that the candidate element should be pulled prior to a particular user interaction, based on the personalization knowledge module's understanding of the user's preferences. For example, the system may determine a user has a regular routine when interacting with an application and determine that a particular candidate element will likely be needed to continue the user interaction. The system may proactively pull the candidate element into the silver storage layer for further processing based on the user's preferences.

In some embodiments, the cache compute engine further includes building the personalized object based on the personalization context provided by the personalization knowledge module. For example, as shown in FIG. 3, the personalization knowledge module 320 may feed context to the in-memory cache compute engine 324. The context may include personalization context that is user specific. Further, the compute servers 326 may, along with the in-memory cache compute engine 324 build the personalized object. In this way, the compute servers 326 may include local cache transmission 328 and in-memory compute 330 that assist in generating the personalized objects. For instance, the compute servers 326 may be fed events and context gathered from the primary interaction gateway layer 306. In this way, the primary interaction gateway layer 306 may provide specific context based on the user device, user interaction, user preferences, or the like.

As shown in block 210, the process flow 200 of this embodiment includes transmitting the personalized object to a memory fabric layer, wherein the memory fabric layer is near a user interface of the user device. In some embodiments, the memory fabric layer includes a first layer of interaction for the user device. The memory fabric layer may include personalized objects generated by the system. The memory fabric may be positioned close to the user device so that the user device may access the personalized objects in an efficient manner. For example, as shown in FIG. 3, the memory fabric 332 may receive the personalized objects from the compute servers 326 and store the personalize data blocks 334 (e.g., personalized objects) near the user device 304. In some embodiments, the consuming applications 302 may be a user device 304 or some other type of device (e.g., a tablet, personal computer, server, etc.). In this way, the consuming application 302 may have quick access to the personalized data blocks 334 specific to the user interaction.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for storage cache personalization and object generation using advanced computational models for data analysis and automated processing, the system comprising:
a processing device;
a non-transitory storage device containing instructions that, when executed by the processing device, causes the processing device to perform the steps of:
receive a user interaction from a user account, wherein the user interaction comprises transaction details associated with a transaction, and wherein the transaction is initiated by a user via a user device;
transmit the user interaction to a service layer, wherein the service layer comprises a personalization knowledge model and a bronze storage, wherein the bronze storage comprises unmodified data associated with the user interaction;
determine a candidate element, wherein the candidate element is based on a preference of the user;
transmit the candidate element to a cache compute engine, wherein the cache compute engine builds a personalized object using the candidate element; and
transmit the personalized object to a memory fabric layer, wherein the memory fabric layer is near a user interface of the user device.

2. The system of claim 1, wherein the transaction details comprise interaction events and session objects associated with the user interaction.

3. The system of claim 1, wherein transmitting the candidate element to a cache compute engine further comprises proactively pulling the candidate element into a silver storage, wherein the silver storage comprises the personalization knowledge module enriching the candidate element.

4. The system of claim 1, wherein the personalization knowledge module further comprises a large language model (LLM), and wherein the LLM proactively determines the candidate element based on historical user interactions.

5. The system of claim 4, wherein the personalization knowledge module further comprises generating personalization context of the candidate elements, wherein the personalization context comprises:
transactional updates, wherein the transactional updates comprise events associated with the user interaction;
common updates, wherein the common updates comprise general configurations associated with the system; and
product rules, wherein the product rules comprise configurations of products associated with the bronze storage.

6. The system of claim 5, wherein the cache compute engine further comprises building the personalized object based on the personalization context provided by the personalization knowledge module.

7. The system of claim 1, wherein the memory fabric layer comprises a first layer of interaction for the user device.

8. A computer program product for storage cache personalization and object generation using advanced computational models for data analysis and automated processing, the computer program product comprising a non-transitory computer-readable medium comprising code causing an apparatus to:
receive a user interaction from a user account, wherein the user interaction comprises transaction details associated with a transaction, and wherein the transaction is initiated by a user via a user device;
transmit the user interaction to a service layer, wherein the service layer comprises a personalization knowledge model and a bronze storage, wherein the bronze storage comprises unmodified data associated with the user interaction;
determine a candidate element, wherein the candidate element is based on a preference of the user;
transmit the candidate element to a cache compute engine, wherein the cache compute engine builds a personalized object using the candidate element; and
transmit the personalized object to a memory fabric layer, wherein the memory fabric layer is near a user interface of the user device.

9. The computer program product of claim 8, wherein the transaction details comprise interaction events and session objects associated with the user interaction.

10. The computer program product of claim 8, wherein transmitting the candidate element to a cache compute engine further comprises proactively pulling the candidate element into a silver storage, wherein the silver storage comprises the personalization knowledge module enriching the candidate element.

11. The computer program product of claim 8, wherein the personalization knowledge module further comprises a large language model (LLM), and wherein the LLM proactively determines the candidate element based on historical user interactions.

12. The computer program product of claim 11, wherein the personalization knowledge module further comprises generating personalization context of the candidate elements, wherein the personalization context comprises:
transactional updates, wherein the transactional updates comprise events associated with the user interaction;
common updates, wherein the common updates comprise general configurations associated with the system; and
product rules, wherein the product rules comprise configurations of products associated with the bronze storage.

13. The computer program product of claim 12, wherein the cache compute engine further comprises building the personalized object based on the personalization context provided by the personalization knowledge module.

14. The computer program product of claim 8, wherein the memory fabric layer comprises a first layer of interaction for the user device.

15. A method for storage cache personalization and object generation using advanced computational models for data analysis and automated processing, the method comprising:
receiving a user interaction from a user account, wherein the user interaction comprises transaction details associated with a transaction, and wherein the transaction is initiated by a user via a user device;
transmitting the user interaction to a service layer, wherein the service layer comprises a personalization knowledge model and a bronze storage, wherein the bronze storage comprises unmodified data associated with the user interaction;
determining a candidate element, wherein the candidate element is based on a preference of the user;
transmitting the candidate element to a cache compute engine, wherein the cache compute engine builds a personalized object using the candidate element; and
transmitting the personalized object to a memory fabric layer, wherein the memory fabric layer is near a user interface of the user device.

16. The method of claim 15, wherein the transaction details comprise interaction events and session objects associated with the user interaction.

17. The method of claim 15, wherein transmitting the candidate element to a cache compute engine further comprises proactively pulling the candidate element into a silver storage, wherein the silver storage comprises the personalization knowledge module enriching the candidate element.

18. The method of claim 15, wherein the personalization knowledge module further comprises a large language model (LLM), and wherein the LLM proactively determines the candidate element based on historical user interactions.

19. The method of claim 18, wherein the personalization knowledge module further comprises generating personalization context of the candidate elements, wherein the personalization context comprises:
transactional updates, wherein the transactional updates comprise events associated with the user interaction;
common updates, wherein the common updates comprise general configurations associated with the system; and
product rules, wherein the product rules comprise configurations of products associated with the bronze storage.

20. The method of claim 19, wherein the cache compute engine further comprises building the personalized object based on the personalization context provided by the personalization knowledge module.
